(19) United States
(12) Patent Application Publication
(10) Pub. No.: US 2013/0057544 A1
(43) Pub. Date: Mar. 7, 2013

(54) AUTOMATIC 3D CLOTHING TRANSFER METHOD, DEVICE AND COMPUTER-READABLE RECORDING MEDIUM

(71) Applicant: Seung Woo Oh, Daejeon (KR)

(72) Inventor: Seung Woo Oh, Daejeon (KR)

(21) Appl. No.: 13/695,143

(22) PCT Filed: Apr. 28, 2010
(86) PCT No.: PCT/KR10/02689

§ 371 Date: Oct. 29, 2012

(30) Foreign Application Priority Data
Apr. 27, 2010 (KR) 10-2010-0038870

(51) Int. Cl. G06T 15/00

(52) U.S. Cl. 345/419

(57) ABSTRACT

Disclosed here is An automatic 3D clothing transfer method comprising the processes of: (a) inputting the first avatar wearing the input clothing and the second avatar which will wear the input clothing; (b) making the input clothing as skin on the first avatar so that the input clothing deforms to the shape change of the first avatar; (c) fitting the first avatar wearing the input clothing as skin to the shape of the second avatar; (d) deforming the input clothing to the fitted shape of the first avatar based on the skinning result of process (b); (e) separating the input clothing from the fitted first avatar and move it onto the second avatar; and (f) draping the clothing without any intersections in the second avatar wearing the separated input clothing. The present invention enables us to automatically drape any 3D clothing on games, movies, TVs and web sites onto any 3D avatar. Further, it provides an automatic 3D clothing transfer method and device, which allows for making the clothing compatible among different sizes, shapes, and topologies of avatars provided by individual online shopping service, thus, for constructing a automatic clothing transfer platform.

### BACKGROUND OF THE INVENTION

1. Field of the Invention

The present invention relates generally to an automatic 3D clothing transfer method, device and computer-readable recording medium, and, more particularly, to a method which automatically drapes any 3D clothing on any avatar regardless of the mesh complexity and topology of the avatar and cloth model.

2. Description of the Related Art

The present invention relates to an automatic 3D clothing transfer method, device and computer-readable recording medium.

Sales of 3D clothing items in the latest online games drastically increases and the world market reaches billions USD in sales. Further, in virtual worlds such as Second Life, IMVU and Puppy Red as well as in online games, the sales of clothing items become main income. If the 3D clothing market is merged with the real clothing market in future, the market size will become larger. However, every existing clothing marketplace service has a critical limitation that the avatar and the clothing are compatible in the service only.

Further, the existing clothing transfer methods work only between the avatars having the same mesh topology. Avatar fitting methods do not work without the feature point given by users. Although the 3D scanning software can automatically extract the feature points, its limited accuracy hampers its application for the avatar fitting in real world.

Further, the existing clothing draping methods require a complicated setting, in which users should arrange every cloth piece appropriately according to its layer before starting the draping, for a successful draping.

### SUMMARY OF THE INVENTION

Accordingly, the present invention has been made keeping in mind the above problems occurring in the prior art, and an object of the present invention is to provide a method and device for automatic 3D clothing transfer which enables us to directly drape the clothing on game, movie, TV and web site onto our own avatar and to make the clothing compatible among different sizes, shapes, topologies of avatars provided by each individual clothing shopping service on the automatic clothing transfer platform where customers can purchase 3D virtual clothing or real clothing.

Another object of the present invention is to provide a fast and automatic method which extracts feature points of avatar and fit the source avatar to the target avatar.

Another object of the present invention is to provide a method which drapes the clothing onto the avatar by iteratively resolving the intersections between avatar and cloth, and cloth and cloth.

Another object of the present invention is to provide a computer-readable medium recording the program of the automatic 3D clothing transfer method.

In order to accomplish the above objects, the present invention includes (a) inputting the first avatar wearing the input clothing and the second avatar which will wear the input clothing; (b) making the input clothing as skin on the first avatar so that the input clothing deforms to the shape change of the first avatar; (c) fitting the first avatar wearing the input clothing as skin to the shape of the second avatar; (d) deforming the input clothing to the fitted shape of the first avatar based on the skinning result of process (b); (e) separating the input clothing from the first fitted avatar and move it onto the second avatar; and (f) draping the clothing without any intersections in the second avatar wearing the separated input clothing.

Further, the process (b) finds the closest position on the first avatar from every vertex of the input clothing, and connects each vertex position of the input clothing and its closest position on the avatar.

Further, the process (c) includes (c1) extracting the feature points from the first avatar and the second avatar; (c2) fitting the overall size and pose of the first avatar to the second avatar so that feature points of both avatars correspond; and (c3) fitting the detailed shape of the first avatar, whose overall size and pose are fitted to the second avatar, to the second avatar.

Further, the process (f) includes (f1) determining if the meshes of the input clothing on the second avatar and the second avatar intersect each other or the inner cloth and outer cloth of the multi-layered clothing intersect each other, and, if the intersections are found, executes the process (f2) and (f3), if not found, skip the process (f2) and (f3) and exits; (f2) pulling the intersected mesh triangle out of the avatar skin by pre-defined force if the avatar and the clothing intersects in the process (f2), and, if the inner cloth and outer cloth of the multi-layered clothing intersect each other, computes the distance field enabling us to determine the inside and outside direction of the second avatar on any 3D position and pushes out the intersected triangles of outer cloth in the gradient direction of the distance field (outside direction) on the intersected position and pulls the intersected triangles of inner cloth against the gradient direction of the distance field (inside direction) by the pre-defined force; and (f3) simulating the draping by exerting the pre-defined force on the intersected mesh triangles and executes after the draping simulation completes.

In the present invention, the computer-readable medium records the program to execute the automatic 3D clothing transfer method.

The present invention, the automatic 3D clothing transfer device, is configured to include Input unit to input the first avatar wearing the input clothing and the second avatar which will wear the input clothing; Skinning unit to make the input clothing as skin on the first avatar so that the input clothing deforms to the shape change of the first avatar; a fitting unit to fit the first avatar wearing the input clothing as skin to the shape of the second avatar; Cloth-Deformation unit to deform the input clothing to the fitted shape of the first avatar based on the skinning result of the Skinning unit; Cloth-Transfer unit to separate the input clothing from the fitted first avatar and move it onto the second avatar; and Draping-Simulation unit to drape the clothing without any intersections in the second avatar wearing the separated input clothing.

Further, the skinning unit is configured to find the closest position on the first avatar from every vertex of the input clothing, and connect each vertex position of the input clothing and its closest position on the avatar.

Further, the fitting unit is configured to extract the feature points from the first avatar and the second avatar, to fit the overall size and pose of the first avatar to the second avatar so that feature points of both avatars correspond, and to fit the detailed shape of the first avatar, whose overall size and pose are fitted to the second avatar, to the second avatar.

Further, Draping unit is configured to include Intersection-Detection unit which determines if the input clothing on the second avatar and the second avatar intersect each other or the inner cloth and outer cloth of the multi-layered clothing intersect each other, and, if the intersections are found, executes the Intersection-Resolution-Force-Creation unit and Draping-Simulation unit, if not found, skip the Intersection-Resolution-Force-Creation unit and Draping-Simulation unit and exits; Intersection-Resolution-Force-Creation unit configured to pull the intersected mesh triangle out of the avatar skin by pre-defined force if the avatar and the clothing intersects in the Intersection-Resolution-Force-Creation unit, and, if the inner cloth and outer cloth of the multi-layered clothing intersect each other, compute the distance field enabling us to determine the inside and outside direction of the second avatar on any 3D position and push out the intersected triangles of outer cloth in the gradient direction of the distance field (outside direction) on the intersected position and pull the intersected triangles of inner cloth against the gradient direction of the distance field (inside direction) by the pre-defined force; and Draping-Simulation unit configured to simulate the draping by exerting the pre-defined force on the intersected mesh triangles and executes Intersection-Detection unit after the Draping-Simulation process finishes.

### BRIEF DESCRIPTION OF THE DRAWINGS

The above and other objects, features and further advantages of the present invention will be more clearly understood from the following detailed description taken in conjunction with the accompanying drawings, in which:

FIG. 1 is a flow chart illustrating the process of the automatic 3D clothing transfer according to an embodiment of the present invention;

FIG. 2 is a flow chart illustrating the step of the Draping stage;

FIG. 3 is a block diagram illustrating the automatic 3D clothing transfer device;

FIG. 4 is a block diagram illustrating the overview of the automatic 3D clothing transfer method;

FIG. 5 is a block diagram illustrating the application and user relationship of the 3D clothing before applying the automatic 3D clothing transfer method; and

FIG. 6 is a block diagram illustrating the application and user relationship of the 3D clothing after applying the automatic 3D clothing transfer method.

### FIG. SYMBOL DESCRIPTION

200: Automatic 3D Clothing Transfer Device

210: Input unit 220: Skinning unit

230: Fitting unit 240: Cloth-Deformation unit

250: Cloth-Transfer unit 260: Draping unit

262: Intersection-Detection unit

264: Intersection-Resolution-Force-Creation unit

266: Draping-Simulation unit

### DESCRIPTION OF THE PREFERRED EMBODIMENTS

Other details of embodiments are included in detailed description and the accompanying drawings.

The advantages, features, and methods of accomplishing the invention will be clearly explained with reference to the embodiments which will be described in detail with reference to the accompanying drawings.

However, the present invention is not limited to the disclosed embodiments below and may be implemented using various other embodiments which are different from each other. The present embodiments are provided to only complete the disclosure of the present invention and to completely inform those skilled in the art of the scope of the present invention. The present invention is to be defined by the scope of the claims. Reference now should be made to the drawings, throughout which the same reference numerals are used to designate the same or similar components. The present invention will be described with reference to the drawings used to describe an automatic 3D clothing transfer method, device and computer-readable recording medium according to the embodiment of the present invention.

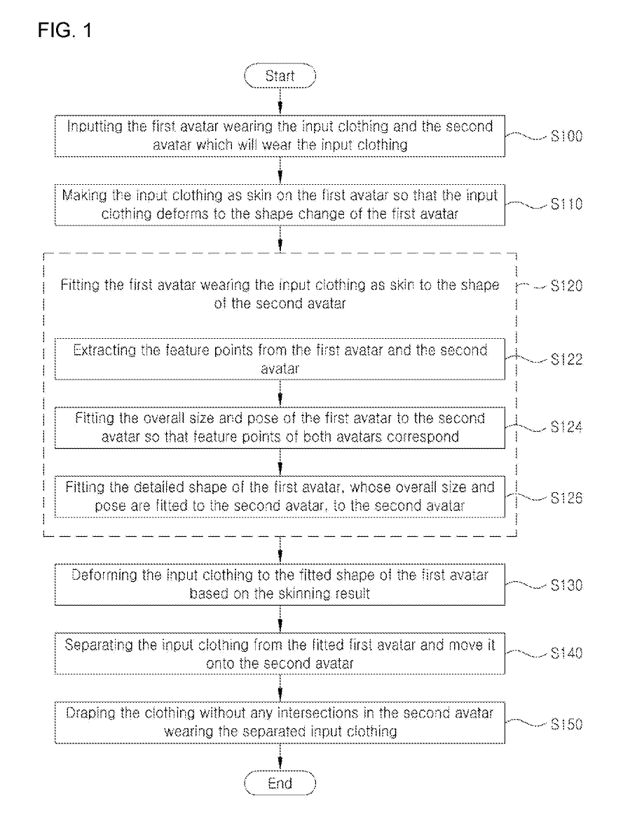

FIG. 1 is a flow chart illustrating the process of the automatic 3D clothing transfer according to an embodiment of the present invention.

The automatic 3D clothing transfer method according to the embodiment of the present invention inputs the input clothing, the first avatar wearing the input clothing, and the second avatar which will wear the input clothing(Process S100).

Then, it makes the input clothing as skin on the first avatar so that the input clothing deforms to the shape change of the first avatar(Process S110).

It is desirable that Process S110 should find the closest position on the first avatar from every vertex of the input clothing, and connect each vertex position of the input clothing and its closest position on the avatar.

In more detail, Process S110 accomplishes skinning data creation task which is to make the clothing as skin of avatar in order to deform the clothing according to the change of the pose or shape of the avatar. This is done by computing the closest position on the avatar skin from every vertex of the clothing mesh.

Here, the process computing the connection between avatar and cloth can be done by using a standard method for the closest distance computation.

For the standard closest distance computation method, you can refer to Seungwoo Oh, Hyungseok Kim, Nadia Magnenat-Thalmann, “Generating unified model for dressed virtual humans”, The Visual Computer, 21 (8-10): 522-531, (Proc. Pacific Graphics 2005), 2005.

In conclusion, since we can achieve the correspondence between all the vertices of the clothing and avatar through the process above, we can make each vertex of the clothing follow its corresponded part of the avatar for deforming the clothing according to the pose and shape of the avatar even if the avatar's shape change drastically.

In the next step, the method fits the first avatar to the second avatar so that the shapes of both avatars match up (Process S120).

It is desirable that Process S120 should include Process S122 to extract the feature points from the first avatar and the second avatar, Process S124 to fit the overall size and pose of the first avatar to the second avatar so that feature points of both avatars correspond, and Process 126 to fit the detailed shape of the first avatar, whose overall size and pose are fitted to the second avatar, to the second avatar.

In more detail, Process S122 is to extract the feature points of the first avatar and the second avatar automatically (refer to Iat-Fai Leong, Fang J J and Tsai M J., “Automatic body feature extraction from a marker-less scanned human body”, Computer-Aided Design, 2007). Here, the feature points indicate the major locations on the avatar body on which the shapes of the first avatar and the second avatar should align after the fitting process.

Here, the feature points can be selected variously according to the fitting method. In general, the top of head, the end point of hand, the end point of foot, ankle, knee, navel, and wrist can be classified into the feature point.

Process S124 tries to fit the shape of the first avatar to that of the second avatar for making the feature points of both avatars coincided while keeping the shape of the first avatar. This fitting process leads to the common optimization process.

The common optimization process is described in [ALLEN, B., CURLESS, B., and POPOVIC Z. 2003. The space of all body shapes: reconstruction and parameterization from range scans. ACM Transactions on Graphics (ACM SIGGRAPH 2003), 22, 3, 587-594].

However, ALLEN's paper, which deals with the algorithm to fit the template avatar model to body-scanned model, is different from the present invention in terms of the automatic feature point extraction for the different topologies of avatars.

In general, the optimization process is a time-consuming task. Therefore, it is desirable that Multigrid method should be applied for Process S126. If we make a success for applying the Multigrid to our fitting problem, it can speed up by one order of magnitude.

In more detail, we can apply Algebraic Multigrid, which is applicable with arbitrary mesh structure(refer to Lin Shi, Yizhou Yu, Nathan Bell and Wei-Wen Feng SIGGRAPH 2006 (ACM Transactions on Graphics, Vol. 24, No. 3, 2006), for the avatar fitting process.

Here, we would like to skip further detailed explanation on the fitting process since the detailed process is described in the papers mentioned above and is clear for those having common knowledge on the avatar fitting.

In the next step, the method deforms the input clothing to the shape of the first avatar based on the skinning result of the Process S110 (Process S130).

In other words, we can easily get the shape of the input clothing fit to the second avatar since the first avatar is already fit to the second avatar and the correspondence between the input clothing and the first avatar is established so that the clothing follows the closes position on the first avatar.

Then, the method separates the input clothing from the fitted first avatar and moves it onto the second avatar (Process S140).

Finally, drape the clothing without any intersections in the second avatar wearing the separated input clothing (Process S150).

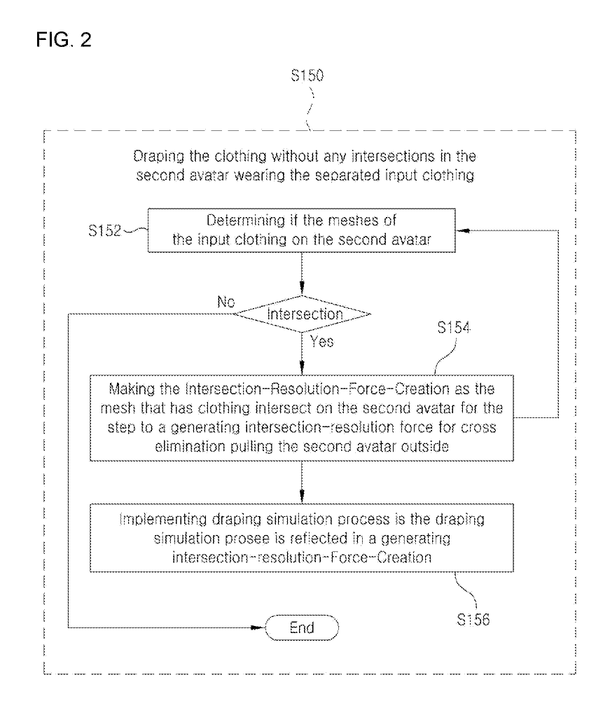

FIG. 2 is a flow chart illustrating the step of the Draping process according to an embodiment of the present invention.

Draping process (Process S150) according to an embodiment of the present invention includes Intersection-Detection process (Process S152), Intersection-Resolution-Force-Creation process (Process S154), and Draping-Simulation process (Process S156).

Here, the method in the Draping-Simulation process is based on the work [Pascal Volino, Nadia Magnenat-Thalmann: Resolving surface collisions through intersection contour minimization. ACM Trans. Graph. 25 (3): 1154-1159 (2006)].

However, Pascal's method has a difficulty on determining the repulsion direction of cloth for resolving the intersection between cloths if the clothing is multi-layered. Thus, the present invention complements the repulsion direction determination mechanism with the distance field will be described below.

Intersection-Detection process (S152) determines if the meshes of the input clothing on the second avatar and the second avatar intersect each other or the inner cloth and outer cloth of the multi-layered clothing intersect each other, and, if the intersections are found, executes S154 and S156, if not found, skip S154 and S156 and exits.

In more detail, Pascal's method enables us to detect the intersections between the second avatar and the input clothing, and the intersections in the input clothing itself.

In Intersection-Resolution-Force-Creation process (S154), the method pulls the intersected mesh triangle out of the avatar skin by pre-defined force if the avatar and the clothing intersects in Process S152, and, if the multi-layered cloth intersects itself, compute the distance field enabling us to determine the inside and outside direction of the second avatar on any 3D position and push out the intersected triangles of outer cloth in the gradient direction of the distance field (outside direction) on the intersected position and pull the intersected triangles of inner cloth against the gradient direction of the distance field (inside direction) by the pre-defined force.

In more detail, if the second avatar and the input clothing draped on the second avatar are intersected, we can use Pascal's method as it is since the intersected clothing triangle should be pulled out of the avatar skin.

In contrary to this, if the inner cloth and outer cloth are intersected in the input clothing, outside direction of avatar on the intersected position is not determined. Therefore, we should determine the direction of the repulsion force by computing the distance field enabling us to determine the inside and outside direction of the second avatar on any 3D position

Here, the distance field can be computed by using [Mark W. Jones and J. Andreas Brentzen and Milos Sramek, 3D distance fields: A survey of techniques and applications, IEEE TRANSACTIONS ON VISUALIZATION AND COMPUTER GRAPHICS, 2006]°ú [Avneesh Sud, Miguel A. Otaduy, Dinesh Manocha, DiFi: Fast 3D Distance Field Computation Using Graphics Hardware, Eurographics, 2004].

The distance field is a data structure which stores the closest distance from the avatar skin to every position in 3D space. For this, the method divides the 3D space into voxels, computes the closest distance from the avatar skin to the center of every voxel, and store the distance in each voxel.

Since the distance field corresponds to the scalar field in terms of mathematics, we can get the gradient of the field.

Here, the gradient of the field is a vector field and the vector indicates the direction along which the scalar values increases the greatest, that is, the direction out of the avatar skin.

If the triangles of the inner cloth and outer cloth intersect, the intersected part is given as a line on the intersected mesh triangles, which we call by Intersect Line. Here the repulsion direction of the outer cloth is given as the gradient of the distance field on the center of Intersect Line, that is, the out-of-avatar direction. In contrary to this, the repulsion direction of the inner cloth is against the out-of-avatar direction.

Draping-Simulation process (S156) simulates the draping by exerting the pre-defined repulsion force on the intersected mesh triangles, computed in Intersection-Resolution-Force-Creation stage, and repeats S152 after the draping simulation process ends.

In more detail, if the method applies the repulsion force to the draping simulation after computing the repulsion force in S154, the number of Intersect Lines will decrease.

Iteratively repeating Intersection-Detection, Intersection-Resolution-Force-Creation and Draping-Simulation process until the intersections are completely resolved, will drape the input clothing onto the second avatar without any intersections even if it has many intersections before the draping.

Since the method can drape the multi-layered clothing without any problems on any avatar, it will be used as the core technology for online clothing marketplace or clothing design software.

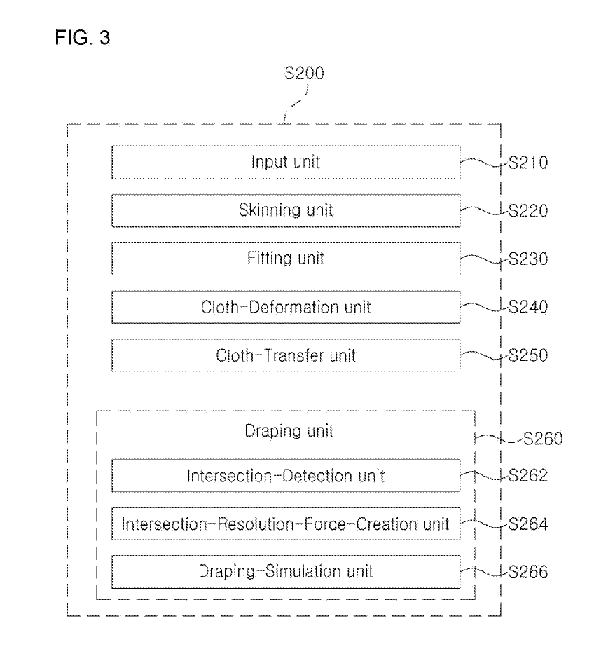

FIG. 3 is a block diagram illustrating the automatic 3D clothing transfer device according to an embodiment of the present invention.

The automatic 3D clothing transfer device according to an embodiment of the present invention (200) includes Input unit (210), Skinning unit (220), Fitting unit (230), Cloth-Deformation unit (240), Cloth-Transfer unit (250) and Draping unit (260).

Input unit (210) inputs the first avatar wearing the input clothing and the second avatar which will wear the input clothing.

Skinning unit (220) makes the input clothing as skin on the first avatar so that the input clothing deforms to the shape change of the first avatar.

Fitting unit (230) fits the first avatar to the second avatar.

Fitting unit (230) is configured to extract the feature points from the first avatar and the second avatar, to fit the overall size and pose of the first avatar to the second avatar so that feature points of both avatars correspond, and to fit the detailed shape of the first avatar, whose overall size and pose are fitted to the second avatar, to the second avatar.

Cloth-Deformation unit (240) to deform the input clothing to the shape of the first avatar based on the skinning result of the Skinning unit.

Cloth-Transfer unit (250) separates the input clothing from the fitted first avatar and moves it onto the second avatar

Draping unit (260) simulates the input clothing by iteratively resolving intersections between avatar and cloth, and cloth and cloth.

Draping unit (260) includes Intersection-Detection unit (262), Intersection-Resolution-Force-Creation unit (264) and Draping-Simulation unit (266).

Intersection-Detection unit determines if the meshes of the input clothing on the second avatar and the second avatar intersect each other or the inner cloth and outer cloth of the multi-layered clothing intersect each other, and, if the intersections are found, asks Intersection-Resolution-Force-Creation unit to compute the repulsion force for resolving the intersections.

Intersection-Resolution-Force-Creation unit (264) pulls the intersected mesh triangle out of the avatar skin by pre-defined force if the avatar and the clothing intersects in the Intersection-Resolution-Force-Creation unit, and, if the inner cloth and outer cloth of the multi-layered clothing intersect each other, compute the distance field enabling us to determine the inside and outside direction of the second avatar on any 3D position and push out the intersected triangles of outer cloth in the gradient direction of the distance field (outside direction) on the intersected position and pull the intersected triangles of inner cloth against the gradient direction of the distance field (inside direction) by the pre-defined force. Then, the unit 264 asks Draping-Simulation unit (266) to execute the draping simulation.

Draping-Simulation unit (266) simulates the draping by exerting the pre-defined force on the intersected mesh triangles and executes after the Draping-Simulation process finishes.

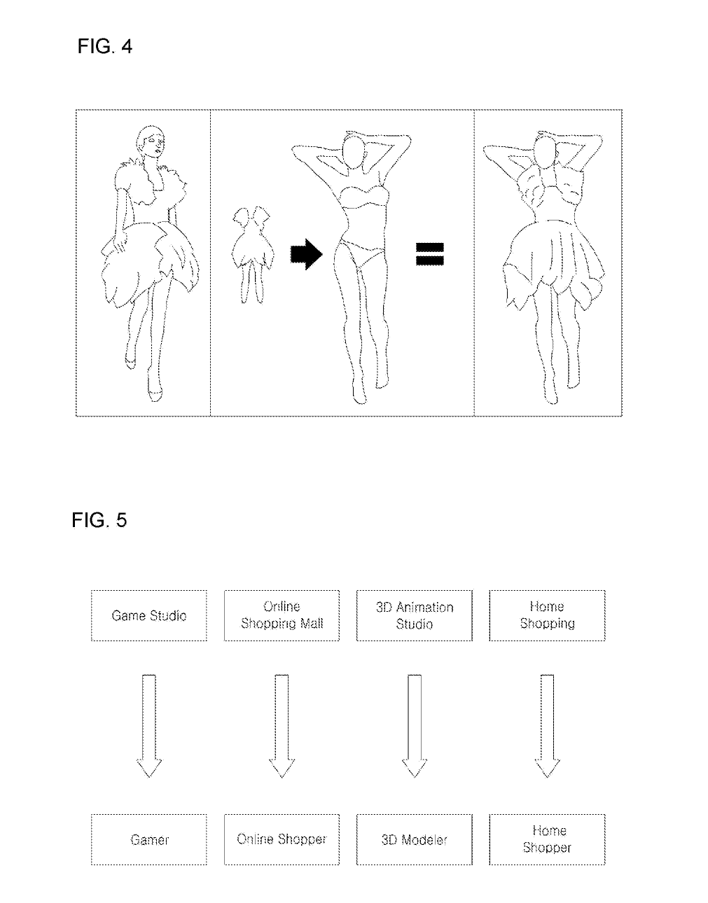

FIG. 4 is a block diagram illustrating the overview of the automatic 3D clothing transfer method according to an embodiment of the present invention.

Considering preferred embodiments of the present invention from FIG. 4, the automatic 3D clothing transfer method provided by the present invention will be used in the fields of body scanning, online clothing marketplace, and 3D clothing design.

The output of the current body scanning system is not useful for movie and game making without any post-processing since the output consists of a complex mesh structure and has many holes, which requires the time-consuming post-process. In contrary to this, the automatic body fitting method provided by the present invention can be directly used for movie and game making since it automatically makes the well-made avatar fit to the body scanning data.

Further, the intersection-free draping method allows for easy coordination and draping of multi-layered cloths for the fields of 3D clothing design and online clothing marketplace.

In other words, the current 3D design software requires a complicated setting in which users should arrange every cloth piece appropriately according to its layer before starting the draping, so that the several layers of cloths are draped well. However, the automatic 3D clothing transfer method removes this complicated setting. Thus, it will be very useful for cloth coordination in online shopping service.

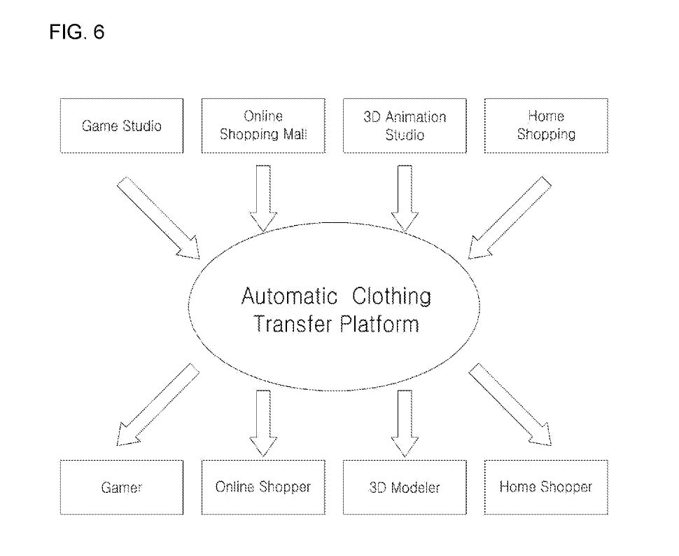

FIG. 5 is a block diagram illustrating the application and user relationship of the 3D clothing before applying the automatic 3D clothing transfer method and FIG. 6 is a block diagram illustrating the application and user relationship of the 3D clothing after applying the automatic 3D clothing transfer method.

Considering the preferred embodiments of the present invention from FIGS. 5 and 6, constructing automatic clothing transfer platform with the automatic 3D clothing transfer method and device makes the avatar and clothing perfectly compatible among different games, movies, virtual worlds, and online shopping services.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An automatic 3D clothing transfer method comprising the processes of:
(a) inputting the first avatar wearing the input clothing and the second avatar which will wear the input clothing;
(b) making the input clothing as skin on the first avatar so that the input clothing deforms to the shape change of the first avatar;
(c) fitting the first avatar wearing the input clothing as skin to the shape of the second avatar;
(d) deforming the input clothing to the fitted shape of the first avatar based on the skinning result of the process (b);
(e) separating the input clothing from the fitted first avatar and move it onto the second avatar; and
(f) draping the clothing without any intersections in the second avatar wearing the separated input clothing.

2. An automatic 3D clothing transfer method as set forth in claim 1, wherein:
the process (b) is configured to find the closest position on the first avatar from every vertex of the input clothing, and connect each vertex position of the input clothing and its closest position on the avatar.

3. An automatic 3D clothing transfer method as set forth in claim 1, wherein:
the process (c) includes:
(c1) extracting the feature points from the first avatar and the second avatar;
(c2) fitting the overall size and pose of the first avatar to the second avatar so that feature points of both avatars correspond; and
(c3) fitting the detailed shape of the first avatar, whose overall size and pose are fitted to the second avatar, to the second avatar.

4. An automatic 3D clothing transfer method as set forth in claim 1, wherein:
the process (f) includes:
(f1) determining if the meshes of the input clothing on the second avatar and the second avatar intersect each other or the inner cloth and outer cloth of the multi-layered clothing intersect each other, and, if the intersections are found, executes the process (f2) and (f3), if not found, skip the process (f2) and (f3) and exits;
(f2) pulling the intersected mesh triangle out of the avatar skin by pre-defined force if the avatar and the clothing intersects in the process (f2), and, if the inner cloth and outer cloth of the multi-layered clothing intersect each other, computes the distance field enabling us to determine the inside and outside direction of the second avatar on any 3D position and pushes out the intersected triangles of outer cloth in the gradient direction of the distance field (outside direction) on the intersected position and pulls the intersected triangles of inner cloth against the gradient direction of the distance field (inside direction) by the pre-defined force; and
(f3) simulating the draping by exerting the pre-defined force on the intersected mesh triangles and executes after the draping simulation completes.

5. A computer-readable recording medium configured to record the program for executing the method of claim 1.

6. An automatic 3D clothing transfer device comprising:
an input unit to input the first avatar wearing the input clothing and the second avatar which will wear the input clothing;
a skinning unit to make the input clothing as skin on the first avatar so that the input clothing deforms to the shape change of the first avatar;
a fitting unit to fit the first avatar wearing the input clothing as skin to the shape of the second avatar;
a cloth-deformation unit to deform the input clothing to the fitted shape of the first avatar based on the skinning result of the skinning unit;
a cloth-transfer unit to separate the input clothing from the fitted first avatar and move it onto the second avatar; and
a draping unit to drape the clothing without any intersections in the second avatar wearing the separated input clothing.

7. An automatic 3D clothing transfer device as set forth in claim 6, wherein: the skinning unit is configured to find the closest position on the first avatar from every vertex of the input clothing, and connect each vertex position of the input clothing and its closest position on the avatar.

8. An automatic 3D clothing transfer device as set forth in claim 6, wherein: the fitting unit is configured to extract the feature points from the first avatar and the second avatar, to fit the overall size and pose of the first avatar to the second avatar so that feature points of both avatars correspond, and to fit the detailed shape of the first avatar, whose overall size and pose are fitted to the second avatar, to the second avatar.

9. An automatic 3D clothing transfer device as set forth in claim 6, wherein the draping unit is configured to include:
an intersection-detection unit which determines if the input clothing on the second avatar and the second avatar intersect each other or the inner cloth and outer cloth of the multi-layered clothing intersect each other, and, if the intersections are found, executes an intersection-resolution-force-creation unit and draping-simulation unit, if not found, skip the intersection-resolution-force-creation unit and draping-simulation unit and exits;
the intersection-resolution-force-creation unit configured to pull the intersected mesh triangle out of the avatar skin by pre-defined force if the avatar and the clothing intersects in the intersection-resolution-force-creation unit, and, if the inner cloth and outer cloth of the multi-layered clothing intersect each other, compute the distance field enabling us to determine the inside and outside direction of the second avatar on any 3D position and push out the intersected triangles of outer cloth in the gradient direction of the distance field (outside direction) on the intersected position and pull the intersected triangles of inner cloth against the gradient direction of the distance field (inside direction) by the pre-defined force; and
a draping-simulation unit configured to simulate the draping by exerting the pre-defined force on the intersected mesh triangles and executes the intersection-detection unit after the draping-simulation process finishes.

10. A computer-readable recording medium configured to record the program for executing the method of claim 2.

11. A computer-readable recording medium configured to record the program for executing the method of claim 3.

12. A computer-readable recording medium configured to record the program for executing the method of claim 4.
